(19) United States
(12) Patent Application Publication
(10) Pub. No.: US 2022/0320637 A1
(43) Pub. Date: Oct. 6, 2022

(54) NON-AQUEOUS COIN-SHAPED BATTERY

(71) Applicant: Panasonic Intellectual Property Management Co., Ltd., Osaka (JP)

(72) Inventor: Tomohiro YAGISHITA, Osaka (JP)

(21) Appl. No.: 17/634,440

(22) PCT Filed: Jun. 1, 2020
(86) PCT No.: PCT/JP2020/021558

§ 371 Date: Feb. 10, 2022

(30) Foreign Application Priority Data
Sep. 26, 2019 (JP) 2019-174883

(51) Int. Cl. H01M 50/119; H01M 50/186; C22C 38/18

(52) U.S. Cl. CPC H01M 50/119; H01M 50/186; C22C 38/18; C22C 2202/02

(57) ABSTRACT

A non-aqueous coin-shaped battery includes a battery case having a bottom plate portion and a side portion rising up from a periphery of the bottom plate portion, a sealing plate having a top plate portion and a peripheral portion extending from the top plate portion to an inside of the side portion, a gasket provided and compressed between the side portion and the peripheral portion, and a power generating element hermetically enclosed by the battery case and the sealing plate. The battery case contains magnetic stainless steel. The stainless steel has a chrome (Cr) content equal to or more than 17% by mass and equal to or less than 32% by mass, and has a grain size number more than 9 and equal to or less than 11.

### TECHNICAL FIELD

The present invention relates to a non-aqueous coin-shaped battery.

### BACKGROUND ART

Non-aqueous coin-shaped batteries are widely used as power sources for small equipment or memory backup. The batteries are required to have excellent storage characteristics in which an internal resistance hardly increases even after long-term storage. On the other hand, as applications of non-aqueous coin-shaped batteries continuously expand, countermeasures against accidental swallowing of a coin-shaped battery becomes more important. When a non-aqueous coin-shaped battery is taken into a living body, a terminal surface of a battery case and a sealing plate of the non-aqueous coin-shaped battery contacts body fluid, causing an electrolysis reaction of water and an oxidation dissolution reaction of an outer can on the positive electrode side. The pH value of the body fluid is substantially neutral. However, as the reaction proceeds, the body fluid near the terminal surface on the negative electrode side changes to alkaline, and the body fluid near the terminal surface on the positive electrode side changes to acidic. When the reaction further proceeds, a through-hole is opened in the outer can on the positive electrode side, and contents flow out into the body. The pH change of the body fluid and the outflow of the contents of the battery may cause serious harm to the living body.

In such a situation, in a small alkaline aqueous solution battery, in order to suppress the dissolution reaction of the outer can on the positive electrode side in accidental ingestion, PTL 1 proposes use of stainless steel having a high chrome (Cr) content for the outer can.

### CITATION LIST

### Patent Literature

PTL 1: Japanese Patent Laid-Open Publication No. 4-312762

### SUMMARY

However, the method of PTL 1 cannot sufficiently suppress a dissolution reaction in a non-aqueous battery having a higher battery voltage.

In view of the above, an object of the present invention is to provide a highly safe non-aqueous coin-shaped battery having excellent storage characteristics and being able to reduce harm to a living body by accidental swallowing.

One aspect of the present invention relates to a non-aqueous coin-shaped battery including a battery case having a bottom plate portion and a side portion rising up from a periphery of the bottom plate portion, a sealing plate having a top plate portion and a peripheral portion extending from the top plate portion to an inside of the side portion, a gasket provided and compressed between the side portion and the peripheral portion, and a power generating element hermetically enclosed by the battery case and the sealing plate. The battery case contains magnetic stainless steel. The stainless steel has a chrome (Cr) content equal to or more than 17% by mass and equal to or less than 32% by mass, and has a grain size number more than 9 and equal to or less than 11.

The present invention has excellent storage characteristics, and can reduce a harm to a living body by accidental swallowing of a non-aqueous coin-shaped battery.

### BRIEF DESCRIPTION OF DRAWINGS

FIG. 1 is a longitudinal sectional view of a non-aqueous coin-shaped battery in accordance with an exemplary embodiment of the present invention.

### DETAIL DESCRIPTION OF PREFERRED EMBODIMENT

A non-aqueous coin-shaped battery in accordance with an exemplary embodiment of the present invention includes a power generating element and an exterior body hermetically enclosing and storing the power generating element. The exterior body includes a bottomed battery case having an opening, a sealing plate closing the opening of the battery case, and a gasket provided between an end (opening end) of a side portion of the battery case and a peripheral portion of the sealing plate. The power generating element includes a first electrode, a second electrode, a separator provided between the electrodes, and an electrolyte. The power generating element fills a space formed by the battery case and the sealing plate. Then, the opening end of the battery case is crimped to a peripheral portion of the sealing plate via the gasket. Thus, the power generating element is hermetically enclosed and stored in the exterior body.

The coin-shaped battery includes a button-shaped battery. In other words, the shape and diameter of the coin-shaped battery are not particularly limited. For example, a button-shaped battery whose battery thickness is larger than the dimeter is also encompassed in the coin-shaped battery.

In more detail, the battery case includes a bottom plate portion and a side portion rising up from a periphery of the bottom plate portion, a first curved portion formed at an interface between the bottom plate portion and the side portion, and a second curved portion formed by crimping. The bottom plate portion often has a circular shape, but may have a shape near circular (for example, an elliptical shape).

The sealing plate includes a top plate portion and a peripheral portion extending from the top plate portion to an inside of the side portion. While the top plate portion has a shape corresponding to the shape of the bottom plate portion, the top plate portion often has a circular shape whose diameter is smaller than that of the bottom plate portion. A thickness T of the coin-shaped battery is often smaller than a diameter D of the bottom plate portion (T<D), and satisfies, for example, 1.2 mm≤T≤5.0 mm, and 9 mm≤D≤24.5 mm. a gasket is provide between the side portion of the case and the peripheral portion of the sealing plate to be compressed between the side portion of the case and the peripheral portion of the sealing plate.

The first electrode and the second electrode have polarities different from each other. In other words, in the case that case that the first electrode is a positive electrode (or a negative electrode), the second electrode is a negative electrode (or a positive electrode). The positive electrode is accommodated in the exterior body and faces the bottom plate portion of the battery case. The negative electrode is accommodated in the exterior body and faces the top plate portion of the sealing plate.

The battery case of the exterior body of the non-aqueous coin-shaped battery is often made of stainless steel having a nickel plating layer on the outer surface thereof. If a non-aqueous coin-shaped battery having such an exterior body is swallowed accidentally, the battery case and the sealing plate are externally short-circuited by body fluid, discharge of the battery proceeds. At this moment, firstly, hydrogen is generated at the sealing plate side by electrolysis of water on the nickel surface on the outer surface, and the body fluid on the periphery of the sealing plate shifts to alkaline. Nickel on the outer surface is easily dissolved in an alkaline environment, an electrolysis reaction of water proceeds on the exposed stainless steel surface, thereby causing the body fluid to further shift to a strong alkaline side. On the other hand, oxygen is generated on the battery case side by the electrolysis reaction of water, and the body fluid around the battery case shifts to acidic. Nickel on the outer surface is easily dissolved in an acidic environment, dissolution by oxidation reaction of the exposed stainless steel proceeds, thereby causing the body fluid to further shift to a strong acidic.

The dissolution reaction of stainless steel preferentially proceeds in the second curved portion. It is because the second curved portion is near the sealing plate, and outer surface thereof has cracking occurring at the time of crimping and has a large contact area with the body fluid. Occurrence of cracking affects the reaction rate, which is remarkable as a battery voltage is higher.

Stainless steel to be used for the battery case of the present invention has magnetic property. When the non-aqueous coin-shaped battery is ingested accidentally, the battery may be taken out from the inside of a living body using a magnet. Types of stainless steel include 400 series ferrite stainless steel, such as SUS444, SUS436, SUS445J1, SUS445J2, and SUS447, and dual phase stainless steel, such as SUS329J1L, SUS329J3L, and SUS329J4L.

The battery case of the present invention is made of stainless steel having a chrome (Cr) content equal to or more than 17% by mass and equal to or less than 32% by mass, and has a grain size number of more than 9 and equal to or less than 11. This range enhances both resistance of the case against solution and the sealing property of the battery.

The Cr content correlates with the resistance to solution and strength of material. In the case that the Cr content is smaller than 17% by mass, the solution resistance becomes insufficient, and the reaction rate at the time of accidental ingestion becomes larger. Furthermore, since the strength is small, during crimping, a large number of minute cracks are produced in the outer side surface of the second curved portion of the case, and the contact area with the body fluid becomes larger to increase the dissolution rate. In the case that the Cr content is more than 32% by mass, the strength of material becomes larger, and the dimension at the time is hardly adjusted when the battery is crimped accordingly deteriorating the sealing property.

In more detail, since spring back after crimping process is large, when the degree of processing is increased in order to keep adhesion between the case and the gasket, the gasket excessively deforms and may be broken between the case and the sealing plate, thus causing sealing property to be insufficient. When the degree of processing is reduced in order not to break the gasket, adhesion degree between the case and the gasket is decreased due to spring back, the sealing property becomes insufficient. The Cr content is preferably equal to or more than 21% by mass and equal to or less than 24% by mass.

The grain size number correlates with the strength. The grain size number equal to or less than 9 decreases the strength. Therefore, a large number of minute cracks are produced in the outer side surface of the second curved portion of the case during crimping, and the contact area with the body fluid becomes larger so as to increase the dissolution rate. The grain size number more than 11 increases the strength of material, and causes the dimension to be hardly adjusted at the time of crimping, thus deteriorating the sealing property.

In more detail, since spring back after crimping process is large, when the degree of processing is increased in order to keep adhesion between the case and the gasket, the gasket is excessively deformed and broken between the case and the sealing plate, the sealing property becomes insufficient. When the degree of processing is reduced in order not to break the gasket, adhesion degree between the case and the gasket is decreased due to spring back, the sealing property becomes insufficient.

The grain size number may be calculated by the following procedure.

Procedure 1: The case is cut, and a cross section of the case at the bottom portion is physically polished and chemically corroded to allow a line structure to appear.

Procedure 2: the number of particles per 1 mm² on an arbitrary portion in the cross section is measured.

Procedure 3: the average number of particles (=m) is calculated based on the measurement results in three portions.

Procedure 4: Particle size number (=G) satisfying m=8×2^{G} is calculated.

The radius of curvature of the second curved portion of the battery case is preferably equal to or more than 0.6 mm and equal to or less than 2.0 mm. The radius of curvature equal to or more than 0.6 mm secures the sealing property of the battery sufficiently. The radius of curvature equal to or less than 2.0 mm reduces occurrence of cracking on the outer side surface of the second curved portion, so that the reaction rate at the time of accidental ingestion is reduced.

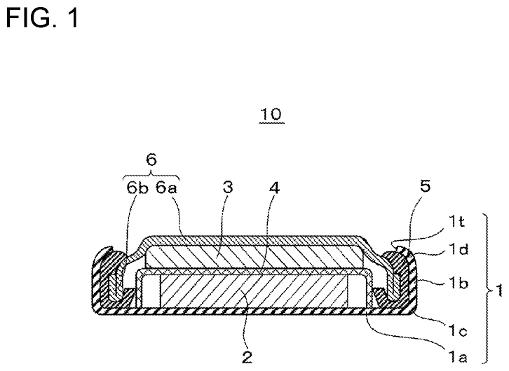

Non-aqueous coin-shaped battery 10 in accordance with the embodiment of the present invention will be described below with reference to FIG. 1. The following exemplary embodiment does not limit the technical scope of the present invention.

The power generating element is accommodated in the exterior body. The power generating element includes positive electrode 2, negative electrode 3, separator 4, and an electrolyte (not shown). In the drawing, positive electrode 2 faces bottom plate portion 1a of battery case 1. Battery case 1 functions as a positive terminal. Negative electrode 3 faces top plate portion 6a of sealing plate 6. Sealing plate 6 functions as a negative electrode terminal.

Examples of material of battery case 1 include stainless steel with Cr content and grain size number which are adjusted. The stainless steel having magnetic property is used for taking out an accidentally ingested battery using a magnet. A nickel plating layer is often formed on the outer surface side of the case made of stainless steel.

Sealing plate 6 is preferably made of a metal plate having excellent mechanical strength. Stainless steel (SUS304, SUS316, SUS430, and the like) is desirably used. However, metal plates made of less expensive common steel, carbon steel, and the like, may be used for the sealing plate. The common steel is a steel material, such as an SS material, an SM material, and an SPCC material defined by Japanese Industrial Standards (JIS). The carbon steel is a steel material, such as S10C, S20C, S30C, S45C, and S55C, and belongs to alloy steel for machine structural use. When the common steel or carbon steel is used, a layer (for example, a nickel-plated layer) for rust prevention is desirably formed on the inner surface side of the battery. The nickel plating layer is often formed on both the inner surface side and outer surface side of the sealing plate made of common steel or carbon steel.

Next, referring to a lithium battery as an example, a method for manufacturing the non-aqueous coin-shaped battery will be described below. The method of manufacturing the non-aqueous coin-shaped batter 10 includes a step (a) of preparing the power generating element, a step (b) of preparing battery case 1, a step (c) of preparing sealing plate 6, a step (d) of preparing gasket 5, and a step (e) of accommodating the power generating element in battery case 1, then closing an opening of battery case 1 by sealing plate 6, and crimping the opening end of battery case 1 to a peripheral portion of sealing plate 6 via gasket 5. A thickness of material of battery case 1 and/or sealing plate 6 ranges, for example, from 0.1 mm to 0.4 mm.

In the step (b), battery case 1 is produced, for example, by drawing a stainless steel plate and forming it to allow the plate has a bottomed cylindrical shape. A nickel plating layer is preferably formed at least on the surface corresponding to the outer surface of the battery of the stainless steel plate.

In the step (c), for example, the sealing plate having a predetermined shape is formed by pressing a metal plate. A nickel plating layer is preferably formed at least on the surface corresponding to the outer surface of the battery.

In the step (d), gasket 5 having an annular groove to be engaged with the peripheral portion of sealing plate 6 is prepared. Gasket 5 may be previously mounted on the peripheral portion of sealing plate 6. As the material of gasket 5, for example, polypropylene (PP), polyphenylene sulfide (PPS), polyether ether ketone (PEEK), or the like, can be used.

In the step (e), the power generating element is accommodated in battery case 1, and sealing plate 6 is disposed so as to close the opening of battery case 1. Then, the open end (the end of the side portion) of battery case 1 is folded inward. Thus, gasket 5 is compressed, and the lower end of gasket 1 tightly contacts the bottom plate portion of the battery case. The upper end of gasket 5 tightly contacts the peripheral portion of sealing plate 6.

Next, taking a lithium battery as an example, the power generating element of the non-aqueous coin-shaped battery will be described. Positive electrode 2 is formed by pressure-forming a positive electrode material mixture into a coin shape. The positive electrode material mixture contains a positive electrode active material, a conductive auxiliary agent, and a binder. The type of the positive electrode active material is not particularly limited, but may be an oxide (for example, manganese dioxide) that is at least one selected from the group consisting of transition metals such as manganese, cobalt, nickel, magnesium, copper, iron, and niobium, or a composite oxide thereof. A composite oxide (for example, LiCoO₂) including at least one selected from the group consisting of metals, such as manganese, cobalt, nickel, magnesium, copper, iron, and niobium. Alternatively, graphite fluoride may be used. The positive electrode active materials may be used singly or in combination of two or more thereof

Examples of the conductive auxiliary agents include carbon black such as acetylene black or Ketjen black, or graphite such as artificial graphite. The conductive auxiliary agents may be used singly or in combination of two or more thereof

Examples of the binder include fluorine resin, styrene-butadiene rubber (SBR), modified acrylonitrile rubber, ethylene-acrylic acid copolymer, and the like. The binders may be used singly or in combination of two or more thereof

Examples of negative electrode 3 include a lithium metal and a lithium alloy having a coin shape. Examples of the lithium alloy include a Li—Al alloy, a Li—Sn alloy, a Li—Si alloy, a Li—Pb alloy, and the like. Negative electrode 3 may be pressure-formed into a coin shape, a negative electrode material mixture that contains a negative electrode active material and a binder. The type of the negative electrode active material is not particularly limited, and examples of the negative electrode active material include a carbon material such as natural graphite, artificial graphite, and non-graphitizable carbon; and a metal oxide such as silicon oxide, lithium titanate, niobium pentoxide, and molybdenum dioxide. As the binder, for example, the above mentioned materials usable for the positive electrode can be arbitrarily used. The negative electrode material mixture may include a conductive auxiliary agent.

The electrolyte includes a non-aqueous solvent, and a solute (salt) dissolved in the non-aqueous solvent. The solute concentration in the electrolyte ranges preferably from 0.3 to 2.0 mol/L. Examples of the non-aqueous solvents may include cyclic carbonate, chain carbonate, chain ether, cyclic ether, and the like. These non-aqueous solvents may be used singly or in combination of two or more thereof. Examples of the solute can include LiBF₄, LiPF₆, LiClO₄, LiCF₃SO₃, LiC₄F₉SO₃, LiN(CF₃SO₂)₂, LiN(C₂F₅SO₂)₂, or the like.

Separator 4 may be made of any materials as long as the material prevents a short circuit between positive electrode 2 and negative electrode 3. Examples of the materials include woven fabric, nonwoven fabric, or microporous film made of polyolefin, polyester, or the like.

Next, the present invention will be specifically described based on Examples. However, the following examples do not limit the present invention. Note here that in this Examples, a non-aqueous coin-shaped battery having a structure shown in FIG. 1 is produced.

### EXAMPLE 1

### (1) Battery Case

A stainless steel plate having a Cr content of 17% by mass and a grain size number of 9.1 is prepared. The stainless steel plate has a thickness of about 200 μm. Nickel plating having a thickness of about 3 μm is applied on one surface of the stainless steel plate. This stainless steel plate is subjected to be drawn to produce battery case 1 including bottom plate portion la having a diameter of 20 mm and side portion 1b having a height of 2.8 mm. In the battery case, the nickel plating is provided on the outer surface side of the battery.

(2) Sealing Plate

A stainless steel plate (SUS430; thickness: 250 μm) having a nickel plating layer having a thickness of 3 μm on one side surface is pressed to produce sealing plate 6 including top plate portion 6a having a diameter of 17 mm. In the sealing plate, that nickel plating is provided at the outer surface side of the battery.

(3) Power Generating Element

A positive electrode material mixture is prepared by mixing 100 parts by mass of manganese dioxide as positive electrode active material, 7 parts by mass of graphite as a conductive auxiliary agent, and 5 parts by mass of polytetrafluoroethylene as a binder. Positive electrode 2 is produced by forming the positive electrode material mixture into a coin shape having a diameter of 15 mm and a thickness of 2 mm. On the other hand, a negative electrode is produced by punching a metal lithium foil having a thickness of 0.6 mm into a circular shape having a diameter of 16 mm. For an electrolyte, an organic electrolyte obtained by dissolving 1.0 mol/L LiClO₄ as a solute in a non-aqueous solvent. The non-aqueous solvent is obtained by mixing propylene carbonate and 1,2-dimethoxyethane at a volume ratio of 2:1.

(4) Assembling of Coin-Shaped Battery

Gasket 5 that is made of polypropylene and is coated with a sealing agent made of blown asphalt and mineral oil is disposed on the inside of side portion 1b of battery case 1. A current collector made of SUS430 is disposed on bottom plate portion 1a. Positive electrode 2 is disposed on the current collector. Next, nonwoven fabric made of polypropylene and having a thickness of 300 μm is disposed as separator 4 on positive electrode 2. Then, the organic electrolyte is injected into battery case 1. Negative electrode 3 is pasted on the inside of top plate 6a of sealing plate 6. Next, sealing plate 6 is disposed so as to close the opening of battery case 1, and the end of side portion 1b of battery case 1 is crimped to peripheral portion 6b of sealing plate 6 via gasket 5. Herein, second curved portion 1d of the case is formed to have the radius of curvature ranging from 1.3 mm to 1.5 mm.

The produced battery is previously discharged by a predetermined electric capacity such that a voltage is 3.20 V to complete coin-shaped battery A1 having a diameter of 20 mm, a thickness of 3.2 mm, and electric capacity of 225 mAh.

Battery A2 is completed in the same manner as battery A1 except that a stainless steel plate having a Cr content of 21% by mass, and a grain size number of 9.1 is used for the material of the battery case.

Battery A3 is completed in the same manner as battery A1 except that a stainless steel plate having a Cr content of 24% by mass, and a grain size number of 9.1 is used for the material of the battery case.

Battery A4 is completed in the same manner as battery A1 except that a stainless steel plate having a Cr content of 32% by mass, and a grain size number of 9.1 is used for the material of the battery case.

### Comparative Example 1

Battery B1 is completed in the same manner as battery A1 except that a stainless steel plate having a Cr content of 16% by mass, and a grain size number of 9.1 is used for the material of the battery case.

Battery B2 is completed in the same manner as battery A1 except that a stainless steel plate having a Cr content of 33% by mass, and a grain size number of 9.1 is used for the material of the battery case.

Evaluation 1

Ten samples of each of non-aqueous coin-shaped batteries A1 to A4, B1 and B2 are prepared.

Processed meat (ham) of pork is placed on the bottom portion of a petri dish having a depth of 15 mm. Then, instead of the body fluid, physiological saline is poured into the petri dish to completely soak the ham in the physiological saline. Next, a battery to be evaluated is mounted on the ham such that the sealing plate contacts the ham. At this moment, the bottom surface of the battery case is slightly lower than the liquid level of the physiological saline so that the battery does not float, thereby allowing a membrane of the saline to be formed on the bottom surface of the case. This state is kept at 25° C. for 30 minutes.

After the test, the state of the ham having contacted the sealing plate is observed visually, discoloration is hardly observed in the ham on which batteries A2, 3, and 4 are mounted. Discoloration is slightly observed in the ham on which batteries A1 and B2 are mounted. While, severe discoloration is observed in the ham on which battery B1 is mounted. Ten samples of batteries in each example show the same tendency.

Next, pH values of the surfaces of the ham after the batteries have been removed are measured, and the average value of 10 values is calculated. The results are shown in Table 1.

Evaluation 2

Ten samples of each of batteries A1 to A4, B1, and B2 are prepared. Batteries to be tested are stored under an environment at 60° C. with 90% of RH for 50 days, then 1 kHz of an alternating-current (AC) voltage is applied across the terminals of the positive electrode and the negative electrode, and the battery resistance is measured. An average value of ten resistance values is calculated. The results are shown in Table 1.

Long-term storage at ordinary temperature of a non-aqueous coin-shaped battery can be accelerated in a storage environment at 60° C. with 90% of RH, and storage for 50 days in this environment is considered to correspond to storage at ordinary temperature for 5 years.

Table 1 shows that batteries A1 to A4, and B1 have low resistance values of less than 40 Ω, but battery B2 has high resistance value of higher than 40 Ω.

TABLE 1

| | A1 | A2 | A3 | A4 | B1 | B2 |
|---|---|---|---|---|---|---|
| Cr content (wt %) | 17 | 21 | 24 | 32 | 16 | 33 |
| Grain | 9.1 | 9.1 | 9.1 | 9.1 | 9.1 | 9.1 |
| size number | | | | | | |
| Discoloration | slightly | hardly | hardly | hardly | strongly | slightly |
| | discolored | discolored | discolored | discolored | discolored | discolored |
| pH | 12.1 | 8.8 | 7.8 | 7.3 | >14 | 7 |
| Internal | 23 | 25 | 27 | 29 | 23 | 41 |
| resistance (Ω) | | | | | | |
| after storage | | | | | | |
| at 60° C. | | | | | | |
| with 90% RH | | | | | | |

Table 1 shows that the battery case made of stainless steel having a grain size number of 9.1 and a Cr content equal to or more than of 17% by mass and equal to or less than 32% by mass reduces the resistance value of the non-aqueous coin-shaped batter after storage at ordinary temperature, and can reduce the harm to a living body even in the case of accidental ingestion.

### EXAMPLE 2

Battery A5 is completed in the same manner as battery A1 except that a stainless steel plate having a Cr content of 17% by mass, and a grain size number of 11.0 is used for the material of the battery case.

Battery A6 is completed in the same manner as in battery A1 except that a stainless steel plate having a Cr content of 21% by mass, and a grain size number of 11.0 is used for the material of the battery case.

Battery A7 is completed in the same manner as battery A1 except that a stainless steel plate having a Cr content of 24% by mass, and a grain size number of 11.0 is used for the material of the battery case.

Battery A8 is completed in the same manner as battery A1 except that a stainless steel plate having a Cr content of 32% by mass, and a grain size number of 11.0 is used for the material of the battery case.

### Comparative Example 2

Battery B3 is completed in the same manner as battery A1 except that a stainless steel plate having a Cr content of 16% by mass, and a grain size number of 11.0 is used for the material of the battery case.

Battery B4 is completed in the same manner as battery A1 except that a stainless steel plate having a Cr content of 33% by mass, and a grain size number of 11.0 is used for the material of the battery case.

Batteries A5 to A8, and B3 and B4 are evaluated as in Evaluations 1 and 2. The results are shown in Table 2.

TABLE 2

| | A5 | A6 | A7 | A8 | B3 | B4 |
|---|---|---|---|---|---|---|
| Cr content (wt %) | 17 | 21 | 24 | 32 | 16 | 33 |
| Grain size | 11 | 11 | 11 | 11 | 11 | 11 |
| number | | | | | | |
| Discoloration | slightly | hardly | hardly | hardly | strongly | slightly |
| | discolored | discolored | discolored | discolored | discolored | discolored |
| pH | 11.8 | 8.4 | 7.3 | 7 | >14 | 6.8 |
| Internal | 33 | 35 | 38 | 39 | 32 | 43 |
| resistance (Ω) | | | | | | |
| after storage | | | | | | |
| at 60° C. | | | | | | |
| with 90% RH | | | | | | |

Table 2 shows that the battery case made of stainless steel having a grain size number of 11 and a Cr content equal to or more than 17% by mass and equal to or less than 32% by mass reduces the resistance value of the coin battery after storage at ordinary temperature and can reduce the harm to a living body even in the case of accidental swallowing.

### Comparative Example 3

Battery B5 is completed in the same manner as n battery A1 except that a stainless steel plate having a Cr content of 17% by mass, and a grain size number of 9.0 is used for the material of the battery case.

Battery B6 is completed in the same manner as battery A1 except that a stainless steel plate having a Cr content of 17% by mass, and a grain size number of 12.0 is used for the material of the battery case.

Batteries B5 and B6 are evaluated as in Evaluations 1 and 2. The results are shown in Table 3.

TABLE 3

| | A1 | A5 | B5 | B6 |
|---|---|---|---|---|
| Cr content (wt %) | 17 | 17 | 17 | 17 |
| Grain size number | 9.1 | 11 | 9 | 12 |
| Discoloration | slightly | slightly | slightly | slightly |
| | discolored | discolored | discolored | discolored |
| pH | 12.1 | 11.8 | >14 | 11.2 |
| Internal resistance | 23 | 33 | 22 | 40 |
| (Ω) after storage at | | | | |
| 60° C. with 90% RH | | | | |

Table 3 shows that he case made of stainless steel having a Cr content of 17% by mass and a grain size number more than 9.0 and equal to or less than 11.0 less reduces the resistance value of the coin battery after storage at ordinary temperature, and can reduce the harm to a living body even in the case of accidental swallowing.

### Comparative Example 4

Battery B7 is completed in the same manner as battery A1 except that a stainless steel plate having a Cr content of 32% by mass, and a grain size number of 9.0 is used for material of the battery case.

Battery B8 is completed in the same manner as battery A1 except that a stainless steel plate having a Cr content of 32% by mass, and a grain size number of 12.0 is used for material of the battery case.

Batteries B7 and B8 are evaluated as in Evaluations 1 and 2. The results are shown in Table 4.

TABLE 4

| | A4 | A8 | B7 | B8 |
|---|---|---|---|---|
| Cr content (wt %) | 32 | 32 | 32 | 32 |
| Grain size number | 9.1 | 11 | 9 | 12 |
| Discoloration | hardly | hardly | hardly | hardly |
| | discolored | discolored | discolored | discolored |
| pH | 7.3 | 7 | 13.9 | 7.2 |
| Internal resistance | 29 | 39 | 28 | 42 |
| (Ω) after storage at | | | | |
| 60° C. with 90% RH | | | | |

Table 4 shows that the case made of stainless steel having a Cr content of 32% by mass and a grain size number more than 9.0 and equal to or less than 11.0 reduces the resistance value of the coin battery after storage at ordinary temperature, and can reduce the harm to a living body even in the case of accidental swallowing.

Tables 1 to 4 show that the case made of stainless steel having a Cr content equal to or more than 17% by mass and equal to or less than 32% by mass and a grain size number more than 9 and equal to or less than 11 reduces the resistance value of the coin-shaped battery after storage at ordinary temperature, and can reduce the harm to a living body even in the case of accidental swallowing.

### INDUSTRIAL APPLICABILITY

The present invention is useful particularly in anon-aqueous coin-shaped battery (for example, a lithium battery) having a battery voltage of more than 3.0 V.

### REFERENCE MARKS IN THE DRAWINGS

1: battery case

1a: bottom plate portion

1b: side portion

1c: first curved portion

1d: second curved portion

1t: end

2: positive electrode

3: negative electrode

4: separator

5: gasket

6: sealing plate

6a: top plate portion

6b: peripheral portion

10: non-aqueous coin-shaped battery

1. A non-aqueous coin-shaped battery comprising:
a battery case having a bottom plate portion and a side portion rising up from a periphery of the bottom plate portion;
a sealing plate having a top plate portion and a peripheral portion extending from the top plate portion to an inside of the side portion;
a gasket provided between the side portion and the peripheral portion, the gasket being compressed between the side portion and the peripheral portion; and
a power generating element hermetically enclosed by the battery case and the sealing plate, wherein
the battery case comprising magnetic stainless steel, the magnetic stainless steel having a chrome (Cr) content equal to or more than 17% by mass and equal to or less than 32% by mass; and
a grain size number more than 9 and equal to or less than 11.

2. The non-aqueous coin-shaped battery according to claim 1, wherein
the battery case includes:
a first curved portion provided on an interface between the bottom plate portion and the side portion; and
a second curved portion extending from the side portion and compressing the gasket, and
a radius of curvature of an outer surface of the second curved portion is equal to or more than 0.6 mm and equal to or less than 2.0 mm.
